(19) United States
(12) Patent Application Publication
(10) Pub. No.: US 2013/0105721 A1
(43) Pub. Date: May 2, 2013

(54) Drive System For An Electro-Mechanical Three-Way Dual Seat Valve

(71) Applicants: Keith R. Kabel, Shelby Township, MI (US); Scott F. Shampine, Rochester Hills, MI (US); Bipin D. Parekh, Plymouth, MI (US)

(72) Inventors: Keith R. Kabel, Shelby Township, MI (US); Scott F. Shampine, Rochester Hills, MI (US); Bipin D. Parekh, Plymouth, MI (US)

(73) Assignee: GM Global Technology Operations LLC, Detroit, MI (US)

(21) Appl. No.: 13/414,968

(22) Filed: Mar. 8, 2012

Related U.S. Application Data
(63) Continuation-in-part of application No. 13/286,452, filed on Nov. 1, 2011.

(51) Int. Cl. F16K 3/00

(52) U.S. Cl. 251/328

(57) ABSTRACT

A three-way dual seat valve having a valve body including mutually spaced apart annular first and second valve seats. Reciprocally mounted with respect to the valve body is a dual-faced valve stem gate, wherein each gate face thereof is sealingly engageable with a respective valve seat in response to reciprocal movement of the valve stem gate effected via a leadscrew drive system.

### CROSS-REFERENCE TO RELATED APPLICATIONS

The present application is a continuation-in-part application of Ser. No. 13/286,452, filed on Nov. 1, 2011, and which is presently pending.

### TECHNICAL FIELD

The present invention relates to valves, including coolant valves typically used in automotive applications. More particularly, the present invention relates to a reciprocating, three-way dual seat valve. Still more particularly, the present invention relates to a leadscrew drive system for providing actuation of the valve.

### BACKGROUND OF THE INVENTION

Valves are ubiquitous in fluid flow systems to provide directional control of the fluid flow therewithin. Valves are used to open and close fluid flow directions, wherein the valve may function between a fully open and fully closed state, or may be progressive, wherein the state of opening is selectively somewhere therebetween so as to meter fluid flow. Valves may be two-way, controlling fluid flow with respect to an inlet and an outlet of the valve, or may be three-way, controlling fluid flow with respect to a pair of inlets and a single outlet of the valve or a pair of outlets and a single inlet of the valve.

Valve sealing is important, and common strategy for sealing is with a face seal against a ball, cylinder, or sleeve. The seals wear due to frictional forces and scrub due to contamination and deposition. Some of these seals need tight tolerances based on their application which can result in high scrap rates. In automotive applications, cold coolant and ambient air temperature tends to require high forces to actuate the valve. Short life and premature leakage are the major issues on this style of valve.

Needle and seat solenoid valves have high pressure drops and excessive energy consumption. Some recent valve designs of this kind utilize a “move and stop” movement versus a “move and hold” movement in order to reduce energy consumption. Pressure drop and energy consumption are the major detriments with this style of valve.

With current valve technology in mind, what is needed is a valve which minimizes the seal surface, reduces or eliminates seal leakage and seal wear for the life of the valve, utilizes hydraulic forces innate to the fluid system to minimize energy consumption to effect tight sealing, provides a high fluid flow coefficient, has the further ability to meter fluid flow, and is provided with an actuation mechanism which minimizes over all valve packaging.

### SUMMARY OF THE INVENTION

The present invention is a three-way dual seat valve which minimizes the seal surface, reduces or eliminates seal leakage and seal wear for the life of the valve, utilizes hydraulic forces innate to the fluid system to minimize energy consumption to effect tight sealing, provides a high fluid flow coefficient, has the further ability to meter fluid flow, and has a leadscrew drive system which minimizes over all valve packaging. Accordingly, the three-way dual seat valve with leadscrew drive system of the present invention has a particularly advantageous application to automotive coolant systems.

The three-way dual seat valve according to the present invention has a valve body including mutually spaced apart annular first and second valve seats. Reciprocally mounted with respect to the valve body is a valve stem which carries within the valve body an annular, dual-faced valve stem gate. Each gate face thereof is sealingly engageable (that is, seatable) with a respective valve seat in response to reciprocal movement of the valve stem. In a preferred environment of use, an inlet of the valve body is disposed between the first and second valve seats, a first outlet of the valve body is disposed downstream of the first valve seat, and a second outlet of the valve body is disposed downstream of the second valve seat; however, the outlet-inlet arrangement may be otherwise.

The valve stem is reciprocated by operation of a leadscrew drive system, wherein an electric motor rotates a screw which is threadingly engaged with respect to a nut connected with the valve stem, wherein an anti-rotation feature is provided as between the valve stem and the valve body to thereby prevent rotation of the valve stem with respect to the valve body. In response, for example, to electronic programming and sensed data available to an electronic control module, the electric motor is selectively actuated to rotate the screw of the leadscrew clockwise or counterclockwise, whereupon the nut of the leadscrew threads along the screw. Since the nut is connected with the valve body, the valve body is prevented from rotating with the screw, and the screw is non-reciprocally movable with respect to the valve body, rotation of the screw results in reciprocation of the valve stem and the valve stem gate thereof.

When the valve stem gate is centrally disposed with respect to the inlet, fluid flows to both the first and second outlets, however as the valve stem gate is moved so as to approach one or the other of the valve seats, fluid flow becomes restricted at the approached valve seat to the outlet respectively thereat, whereby proportional fluid flow may be established if the valve stem gate is held separated at a selected separation distance from the approached valve seat. When the valve stem gate is seated at either of the first and second valve seats, the engaging gate face thereof sealingly abuts the valve seat, assisted by hydraulic pressure (when present) of the fluid, whereby fluid flow is prevented from passing through the now closed valve seat and only passes through the other, open, valve seat and its respective outlet. Upon movement of the valve stem in the opposite direction, the sealing of the other valve seat is effected by sealing abutment with the other gate face of the valve stem gate, and fluid flow is then possible only through the respectively other of the outlets.

As the gate face of the valve stem gate separates from its respective valve seat fluid flow therepast will be relatively rapid, depending upon fluid pressure, due to the small annular separation distance between the valve seat and the valve stem gate, whereby any debris disposed thereat will be flushed away by the rushing fluid.

Accordingly, it is an object of the present invention to provide a three-way dual seat valve which minimizes the seal surface, reduces or eliminates seal leakage and seal wear for the life of the valve, utilizes hydraulic forces innate to the fluid system to minimize energy consumption during operation of the valve, provides a high fluid flow coefficient, and has the further ability to meter fluid flow.

This and additional objects, features and advantages of the present invention will become clearer from the following specification of a preferred embodiment.

### BRIEF DESCRIPTION OF THE DRAWINGS

FIG. 1 is a partly sectional side view of a three-way dual seat valve, showing an electro-magnetic actuation system therefor, further showing a valve stem gate thereof at a neutral position with respect to first and second valve seats, and yet further showing an interface of the three-way dual seat valve with a fluid flow system depicted in phantom.

FIG. 2 is a sectional view, seen along line 2-2 of FIG. 1.

FIG. 3 is a sectional view, seen along line 3-3 of FIG. 1.

FIG. 4 is a sectional view of the three-way dual seat valve of FIG. 1, wherein now the valve stem gate is seated at the first valve seat.

FIG. 5 is a sectional view, seen along line 5-5 of FIG. 4.

FIG. 6 is a sectional view, seen along line 6-6 of FIG. 4.

FIG. 7 is a sectional view of the three-way dual seat valve of FIG. 1, wherein now the valve stem gate is seated at the second valve seat.

FIG. 8 is a sectional view of the three-way dual seat valve of FIG. 1, wherein now the valve stem gate is separated a small distance from the second valve seat.

FIG. 9 is a sectional view, seen along line 9-9 of FIG. 8.

FIG. 10 is a sectional view of a three-way dual seat valve similar to FIG. 1, wherein now the first and second valve seats (rather than the stem gate) are provided a valve seal.

FIG. 11 is a sectional view of a three-way dual seat valve similar to FIG. 1, wherein now the first and second valve seats and the valve gate are provided with a valve seal.

FIG. 12 is a sectional view of a three-way dual seat valve similar to FIG. 1, wherein now none of the first and second valve seats and the valve gate are provided with a valve seal.

FIG. 13 is a sectional side view of a three-way dual seat valve including a leadscrew drive system actuation system according to the present invention, wherein the leadscrew is composed of an electrically driven screw threaded with respect to a nut formed in the valve stem, and wherein an anti-rotation feature is disposed at the valve stem guide.

FIG. 14 is a sectional side view of a three-way dual seat valve including a leadscrew drive system actuation system as in FIG. 13, wherein now the valve gate is disposed seated at the other valve seat of the valve body in response to actuation of the leadscrew drive system.

FIG. 15 is a sectional view, seen along line 15-15 of FIG. 14, showing the anti-rotation feature of FIG. 13.

FIG. 16 is a sectional side view of a three-way dual seat valve including a leadscrew drive system actuation system according to the present invention, wherein the leadscrew is composed of an electrically driven screw threaded with respect to a nut formed in the valve stem, and wherein an anti-rotation feature is disposed at the valve body.

FIG. 17 is a sectional side view of a three-way dual seat valve including a leadscrew drive system actuation system as in FIG. 16, wherein now the valve gate is disposed seated at the other valve seat of the valve body in response to actuation of the leadscrew drive system.

FIG. 18 is a sectional view, seen along line 18-18 of FIG. 17, showing the anti-rotation feature of FIG. 16.

FIG. 19 is a sectional side view of a three-way dual seat valve including a leadscrew drive system actuation system according to the present invention, wherein the leadscrew is composed of an electrically driven screw threaded with respect to a nut formed in the valve stem gate, and wherein an anti-rotation feature is disposed at the valve body.

FIG. 20 is a sectional side view of a three-way dual seat valve including a leadscrew drive system actuation system as in FIG. 16, wherein now the valve gate is disposed seated at the other valve seat of the valve body in response to actuation of the leadscrew drive system.

FIG. 21 is a sectional view, seen along line 21-21 of FIG. 17, showing the first example of the anti-rotation feature of FIG. 16 and the threading engagements of the leadscrew of FIG. 19.

### DESCRIPTION OF THE PREFERRED EMBODIMENT

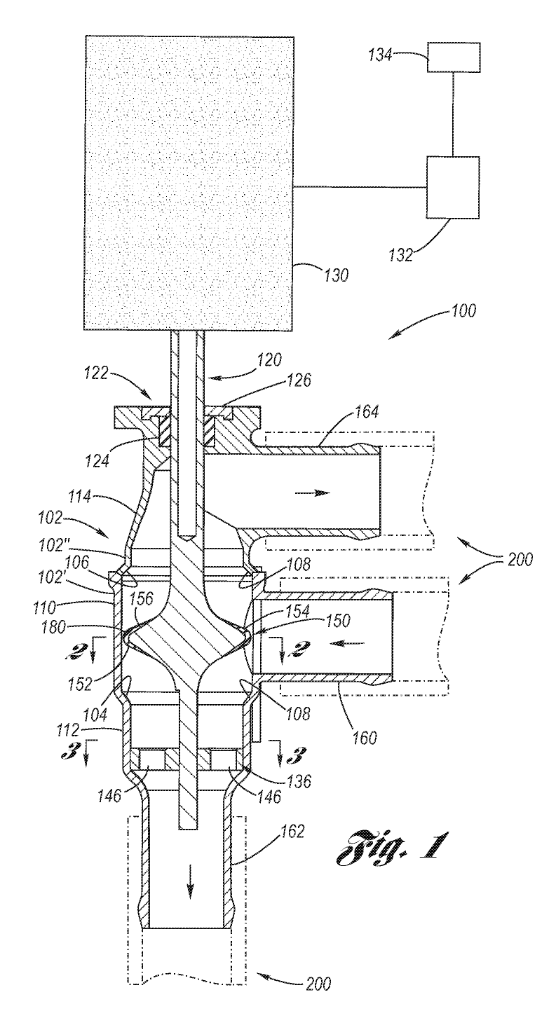

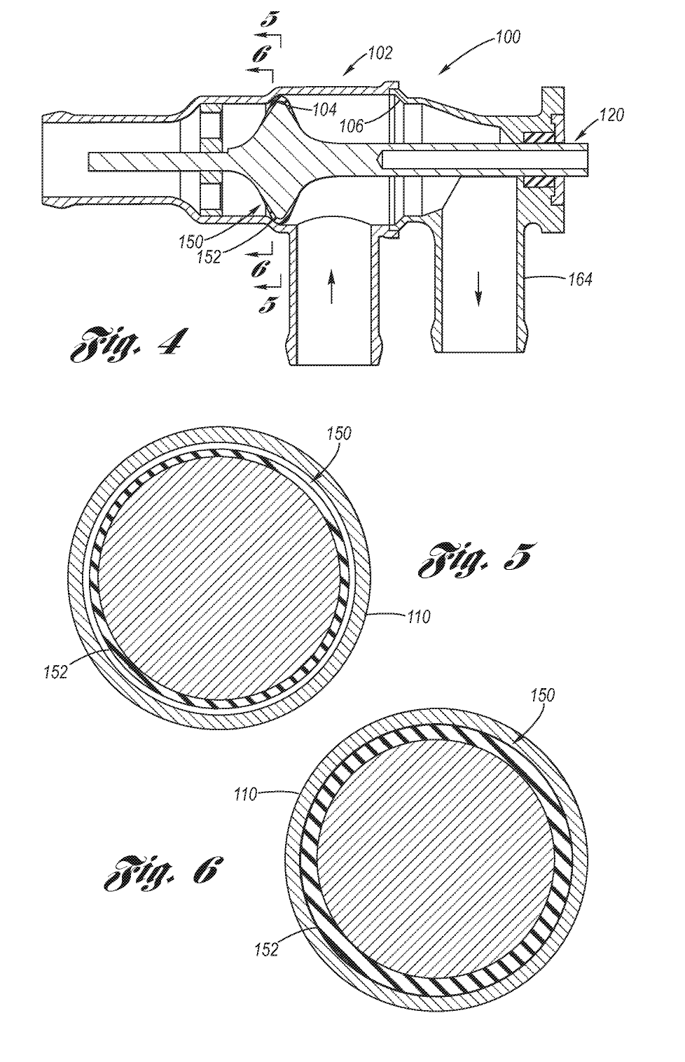

Referring now to the Drawings, FIGS. 1 through 12 depict various exemplary aspects of the structure and function of a three-way dual seat valve, and FIGS. 13 through 21 depict various exemplary aspects of a leadscrew drive system according to the present invention for the three-way dual seat valve.

Referring firstly to FIGS. 1 through 12, a three-way dual seat valve 100 will now be detailed. This three-way dual set valve 100 is described in U.S. patent application Ser. No. 13/286,452, filed on Nov. 1, 2011, to K. R. Kabel, entitled “Electro-Mechanical Three-Way Dual Seat Valve”, and assigned to the assignee hereof, wherein the disclosure of said application is hereby incorporated herein by reference.

The three-way dual seat valve according to the present invention includes a valve body 102 which, for purposes of manufacture, is composed of first and second valve body members 102′, 102″ which are mutually welded, threaded or otherwise sealingly joined and mechanically affixed. Within the valve body 102 is a pair of mutually separated annular valve seats, a first valve seat 104 and a second valve seat 106, each being preferably characterized by an annular bevel or taper 108. A medial valve body portion 110 of the valve body 102 is disposed between the first and second valve seats 104, 106. A first distal valve body portion 112 of the valve body 102 is disposed adjoining the first valve seat 104 in juxtaposed relation to the medial valve body portion 110. A second distal valve body portion 114 of the valve body 102 is disposed adjoining the second valve seat 106 in juxtaposed relation to the medial valve body portion 110.

A valve stem 120 passes through the valve body 102 and exits at the second distal valve body portion 114, guided and sealed by gland 122 composed of packing 124 retained by a cap 126. The exiting portion of the valve stem 120 is connected with a linear actuator 130, most preferably an electro-magnetic actuator which is, for example, actuated in response to a signal from an electronic control module 132 having programming which reacts in a predetermined manner to data sensed by one or more sensors 134.

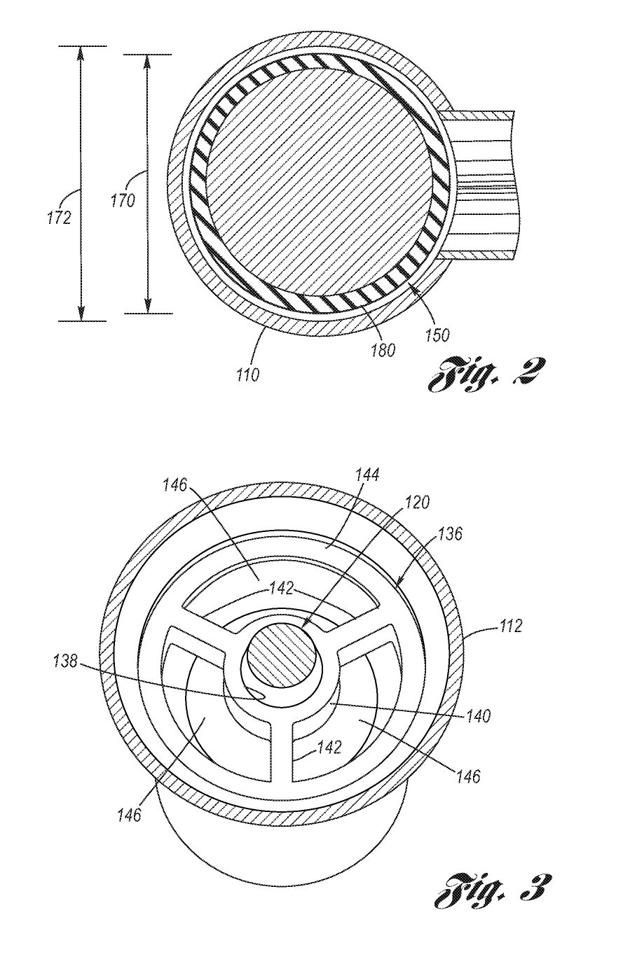

Guidance of reciprocation of the valve stem 120 in response to activation of the actuator 130 is provided additionally by a valve stem guide 136 which is attached to the first distal valve body portion 112. As best shown at FIG. 3, the valve stem 120 passes through a stem guide opening 138 which is defined by an annular stem guidance collar 140 supported by a plurality of stem guide arms 142 which connect to an annular stem guide attachment collar 144 affixed to the first distal valve body portion. The stem guide arms 142 are separated to provide a fluid flow passage 146 through the valve stem guide 136.

The valve stem 120 carries within the medial valve body portion 110 of the valve body 102 an annular, dual-faced valve stem gate 150, having a first gate face 152 which is sealingly seatable with respect to the first valve seat 104, and further having a second gate face 154 which is sealingly seatable with respect to the second valve seat 106, the seating being in response to reciprocal movement of the valve stem 120 via the actuator 130.

A first fitting 160 is connected with the valve body 102 with respect to the medial valve body portion 110, being disposed preferably centrally between the first and second valve seats 104, 106; a second fitting 162 is connected with the valve body 102 at the first distal valve body portion 112; and a third fitting 164 is connected with the valve body 102 at the second distal valve body portion 114. In the preferred environment of use of the three-way dual seat valve 100, the first fitting 160 is an inlet of a fluid flow system 200 disposed upstream of the first and second valve seats 104, 106, the second fitting 162 is an outlet of the fluid flow system disposed downstream of the first valve seat 104, and the third fitting 164 is an outlet of the fluid flow system disposed downstream of the second valve seat 106. However, the outlet-inlet assignment of the fittings may be otherwise.

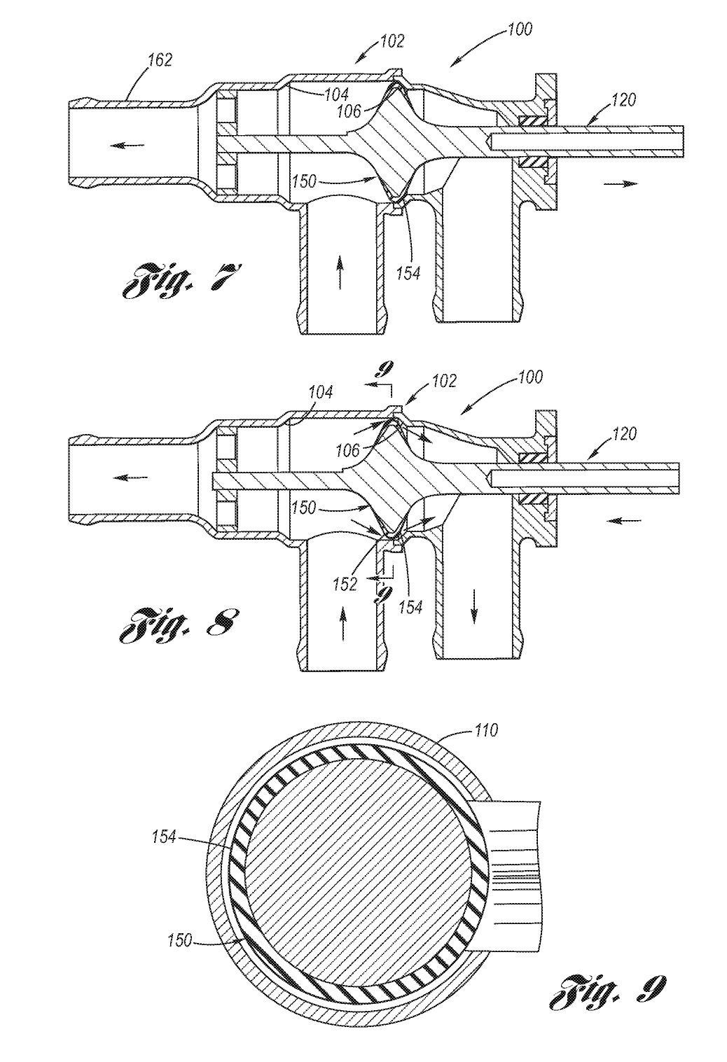

When the valve stem gate 150 is centrally disposed with respect to the first fitting 160, as shown at FIG. 1, fluid flows from the first fitting (serving as the inlet) to both of the second and third fittings 162, 164 (both serving as outlets). In response to activation of the actuator 130, the valve stem 120 reciprocates in one direction or the other and in so doing approaches one or the other of the valve seats 104, 106. As this occurs, fluid flow becomes restricted at the approached valve seat and, consequently also with respect to the outlet respectively thereat. In this manner proportional fluid flow may be established if the valve stem gate 120 is held separated at a selected separation distance from the approached valve seat 104, 106 (see FIG. 8).

When the valve stem gate is seated at either the first valve seat 104, as shown at FIG. 4, or at the second valve seat 106, as shown at FIG. 7, the respectively engaging first or second gate face 152, 154 sealingly abuts the valve seat, assisted by hydraulic pressure (when present) of the fluid. In this regard with respect to FIG. 4, fluid flow is prevented from passing through the now closed first valve seat 104 and only passes through the other, open, second valve seat 106 and its respective outlet fitting 164. Upon movement of the valve stem 120 in the opposite direction, as shown at FIG. 7, fluid flow is prevented from passing through the now closed second valve seat 106 and only passes through the other, open, first valve seat 104 and its respective outlet fitting 162.

Referring now in particular to FIG. 8, as either of the first and second gate faces 152, 154 separate from its respective valve seat 104, 106 fluid flow therepast will be relatively rapid, depending upon fluid pressure, due to the small annular separation distance between the valve seat and the valve stem gate 150, whereby any debris disposed thereat will be flushed away by the rushing fluid.

As can be appreciated by reference to FIG. 2, the outer diameter 170 of the valve stem gate 150 is preferably less than the inside diameter 172 of medial valve body portion 110. Accordingly, as can be appreciated by reference additionally to FIG. 1, the valve stem gate will not scrape the valve body 102 during reciprocation between the first and second valve seats 104, 106, only sealing at a beveling or taper 108 which defines the respective valve seat.

Additionally, the medial valve body portion 110, the first distal valve body portion 112 and the second distal valve body portion 114 are cross-sectionally sized with respect to that of the first, second and third fittings such that fluid flow has a high flow coefficient within the valve body 102. In this regard, the cross-section of the first distal valve body portion 112 is larger than the cross-section of the second fitting 162 such that the fluid flow passage 146 is cross-sectionally sized with respect to that of the second fitting such that the high coefficient of fluid flow is provided.

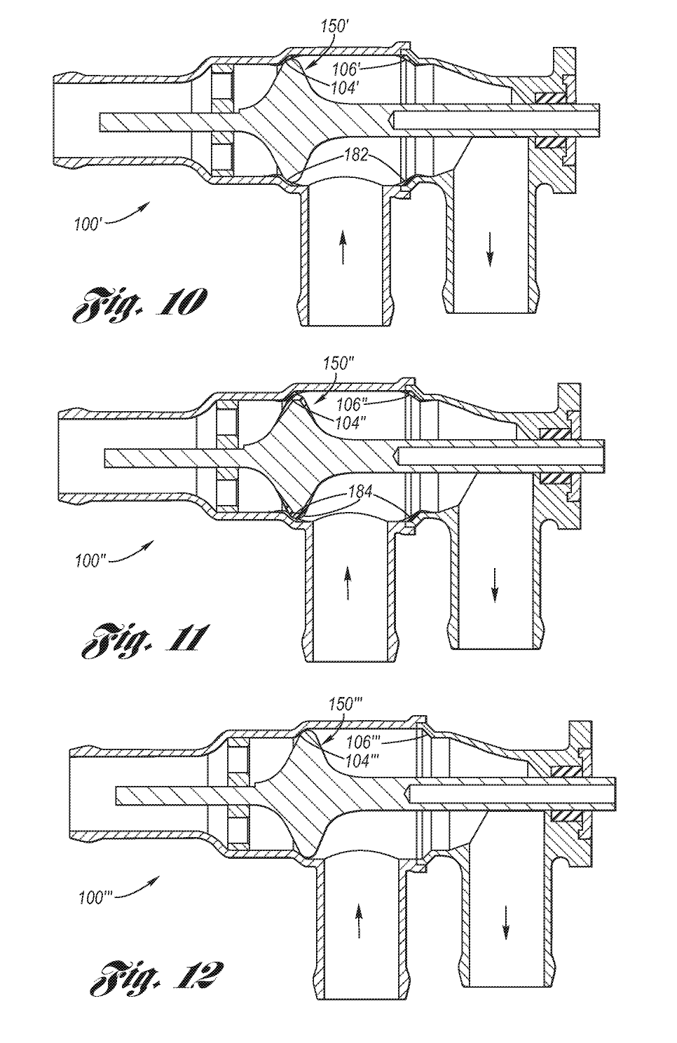

FIGS. 1 through 9 depict the three-way dual seat valve 100 according to the present invention having a valve seal 180, as for example an elastomeric material, disposed at the valve stem gate 150. In this regard the valve seal 180 is an overmold of the valve stem gate core 156 of the valve stem gate 150 jointly at the first and second gate faces 152, 154. However, as shown at FIG. 10, the three-way dual seat valve 100′ of the present invention may have a valve seal 182 disposed, preferably as an overmold, at the first and second valve seats 104′, 106′, and the valve stem gate 150′ is free of a valve seal. However further, as shown at FIG. 11, the three-way dual seat valve 100″ of the present invention may have a valve seal 184 disposed, preferably as an overmold at both the valve stem gate 150″ and the first and second valve seats 104″, 106″. Indeed, as shown at FIG. 12, the three-way dual seat valve 100′″ of the present invention may have no valve seal at both the valve stem gate 150′″ and the first and second valve seats 104′″, 106′″, wherein the valve stem gate and the first and second valve seats can be composed of similar material, or harder or softer material collectively or respectively, depending on the environment of use of the present invention.

Referring now to FIGS. 13 through 21, examples of a leadscrew drive system for reciprocating the valve stem gate between the first and second valve seats will now be described.

FIG. 13 depicts, in accordance generally with the discussion hereinabove with respect to FIGS. 1 through 12, a three-way dual seat valve 300 including a valve body 302 within which is a pair of mutually separated annular valve seats, a first valve seat 304 and a second valve seat 306. A medial valve body portion 310 of the valve body 302 is disposed between the first and second valve seats 304, 306. A first distal valve body portion 312 of the valve body 302 is disposed adjoining the first valve seat 304 in juxtaposed relation to the medial valve body portion 310. A second distal valve body portion 314 of the valve body 302 is disposed adjoining the second valve seat 306 in juxtaposed relation to the medial valve body portion 310. A first fitting 360 is connected with the valve body 302 with respect to the medial valve body portion 310; a second fitting 362 is connected with the valve body at the first distal valve body portion 312; and a third fitting 364 is connected with the valve body at the second distal valve body portion 314. In the preferred environment of use of the three-way dual seat valve 300, the first fitting 360 is an inlet of a fluid flow system 200′ disposed upstream of the first and second valve seats 304, 306, the second fitting 362 is an outlet of the fluid flow system disposed downstream of the first valve seat, and the third fitting 364 is an outlet of the fluid flow system disposed downstream of the second valve seat. However, the outlet-inlet assignment of the fittings may be otherwise. A valve stem 320 passes through the valve body 302 and exits at the second distal valve body portion 314, guided and sealed by gland 322 composed of packing 324 retained by a cap 326. Guidance of reciprocation of the valve stem 320 is additionally provided by a valve stem guide 336 which is attached to the first distal valve body portion 312. The valve stem 320 passes through a stem guide opening of the valve stem guide 336, as will be detailed hereinbelow with respect to FIG. 15, which is defined by an annular stem guidance collar 340 supported by a plurality of stem guide arms 342 which connect to an annular stem guide attachment collar 344 affixed to the first distal valve body portion. The stem guide arms 342 are separated to provide a fluid flow passage 346 through the valve stem guide 336. Additionally, the medial valve body portion 310, the first distal valve body portion 312 and the second distal valve body portion 314 are cross-sectionally sized with respect to that of the first, second and third fittings such that fluid flow has a high flow coefficient within the valve body 302. In this regard, the cross-section of the first distal valve body portion 312 is larger than the cross-section of the second fitting 362 such that the fluid flow passage 346 is cross-sectionally sized with respect to that of the second fitting such that the high coefficient of fluid flow is provided. The valve stem 320 carries within the medial valve body portion 310 of the valve body 302 an annular, dual-faced valve stem gate 350, having a first gate face 352 which is sealingly seatable with respect to the first valve seat 304, and further having a second gate face 354 which is sealingly seatable with respect to the second valve seat 306, the seating being in response to reciprocal movement of the valve stem 320. The first and second valve seats and/or the valve stem gate may or may not be provided with an overmold of elastomeric seal material, as described hereinabove, the views in FIGS. 13 through 22 not showing an overmold merely by way of example.

In accordance with the present invention, FIGS. 13 through 15 show a first example of the leadscrew drive system 400 for reciprocating the valve stem gate 350 between the first and second valve seats 304, 306.

The valve stem 320 is provided with a threaded blind bore 402 which serves as the nut 404 of a leadscrew 410 of the leadscrew drive system 400. A threaded shaft 406 serves as the screw 408 of the leadscrew 410, wherein the screw is threadingly engaged on the nut 404. The threaded shaft 406 is drivingly connected to an electric motor 416, as for example a stepper motor, wherein by way of example the threaded shaft may be connected by gearing or directly (as shown) to the armature 418. By way of example, the stator 420 is connected to an external electrical circuit including an electronic control module 422 having programming which reacts in a predetermined manner to data sensed by one or more sensors 424. The electric motor 416 is compactly connected with the valve body 302, for example disposed in circumscribing relation to the gland 322.

An anti-rotation feature 428 is provided in which the valve stem 320 is prevented from rotating with respect to the valve body 302. In this regard, the valve stem 320 passes through a non-circular stem guide opening 430, as for example a D-shaped opening, as shown at FIG. 15. The portion of the valve stem which passes through the non-circular stem guide opening is complementarily shaped, as for example also D-shaped, such that the stem guide is prevented from rotating by a sliding interference fit 440 at the non-circular stem guide opening.

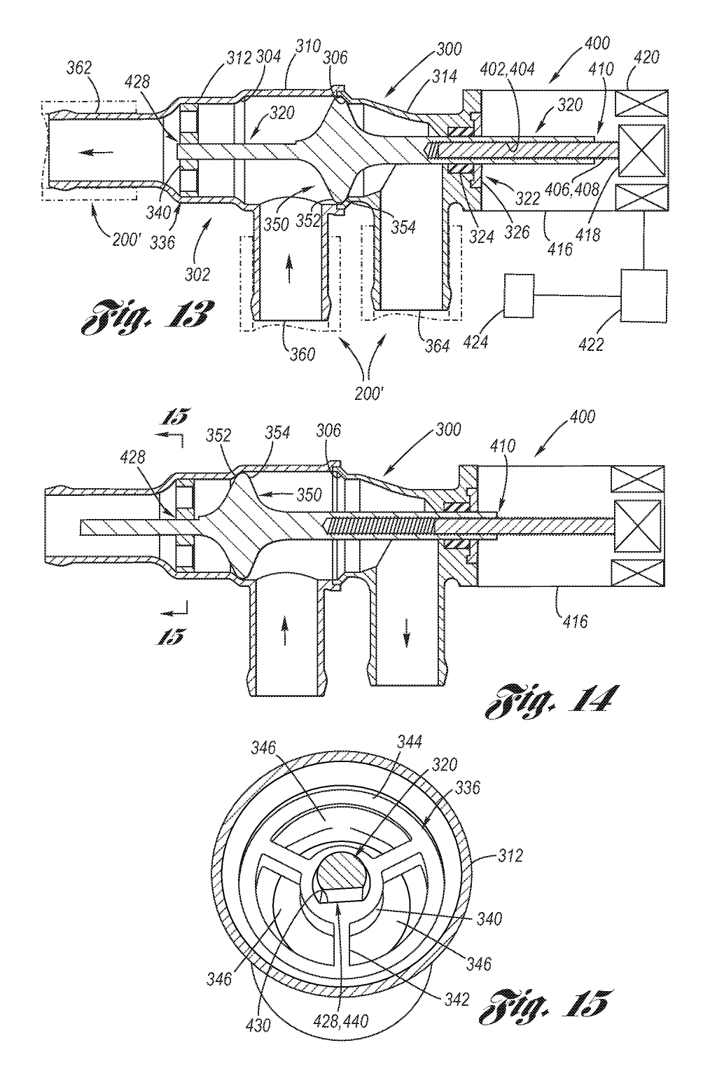

In operation, the valve stem 320 is reciprocated by the leadscrew drive system 400, wherein when electric motor 416 (that is to say more particularly the armature 418 thereof) rotates, the threaded shaft 406 rotates with respect to the threaded blind bore 402 in that the valve stem is prevented from rotating by the anti-rotation feature 428. In response, for example, to electronic programming and sensed data available to an electronic control module 422, the electric motor is selectively actuated to rotate the screw 408 of the leadscrew 410 clockwise or counterclockwise, whereupon the nut 404 of the leadscrew threads along the screw. Since 1) the nut is connected with the valve stem (and consequently the valve stem gate 350), 2) the valve stem is prevented from rotating with the screw because of the anti-rotation feature 428, and 3) the threaded shaft (e.g., the screw) is non-reciprocally mounted to the electric motor such that it is non-reciprocal with respect to the valve body, rotation of the screw results in reciprocation of the valve stem and the valve stem gate thereof between the position shown in FIG. 14, wherein the valve stem gate is sealingly seated at the first valve seat 304 to the position shown at FIG. 13, wherein the valve stem gate is sealingly seated at the second valve seat 306, and anywhere inbetween (as per the view at FIG. 1), wherein fluid flow is controlled as described hereinabove.

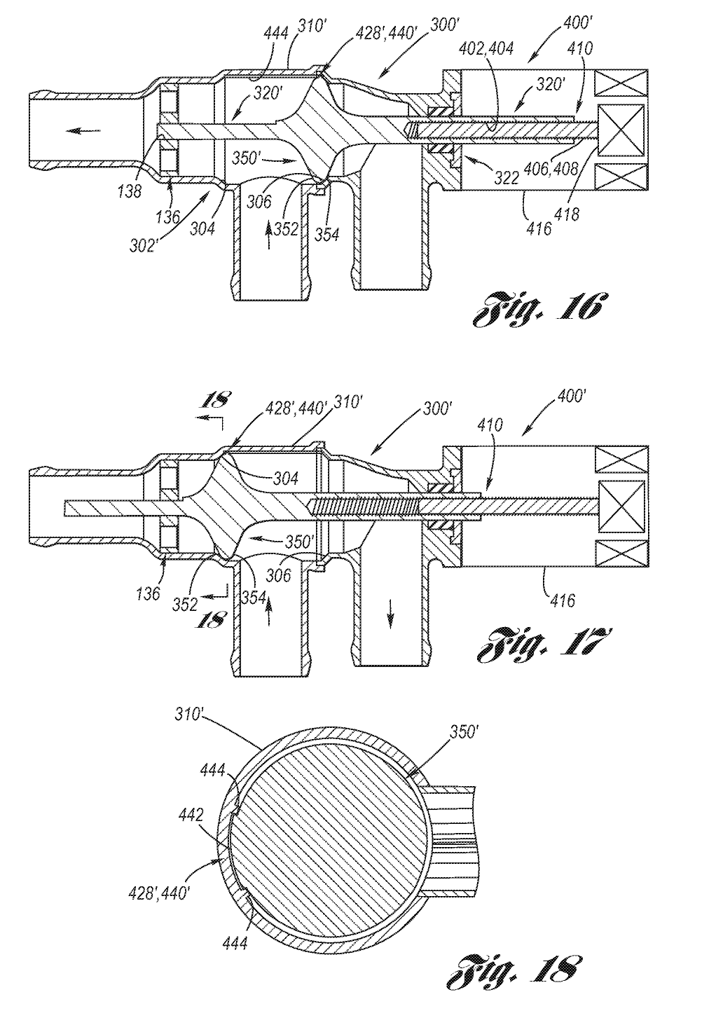

In further accordance with the present invention, FIGS. 16 through 18 show a second example of the leadscrew drive system 400′ for reciprocating the valve stem gate 350′ between the first and second valve seats 304, 306.

As in FIG. 13, the three-way dual seat valve 300′ has a valve stem 320 is provided with a threaded blind bore 402 serves as the nut 404 of a leadscrew 410 of the leadscrew drive system 400. A threaded shaft 406 serves as the screw 408 of the leadscrew 410, wherein the screw is threadingly engaged on the nut 404. The threaded shaft 406 is drivingly connected to an electric motor 416, as for example a stepper motor, wherein by way of example the threaded shaft may be connected by gearing or directly (as shown) to the armature 418. By way of example, the stator 420 is connected to an external electrical circuit including an electronic control module having programming which reacts in a predetermined manner to data sensed by one or more sensors (as per FIG. 13). The electric motor 416 is compactly connected with the valve body 302′, for example disposed in circumscribing relation to the gland 322. Unlike, however, FIG. 13, the valve stem 320′ passes through a circular stem guide opening, as for example 138 of the valve stem guide 136 at FIG. 2, and operates guidingly as described hereinabove with respect to FIG. 2.

An anti-rotation feature 428′ is provided in which the valve stem 320′ is prevented from rotating with respect to the valve body 302′. In this regard, the valve stem gate 350′ now has a sliding interference fit 440′ with respect to the valve body which prevents relative rotation, but allows relative reciprocation. This interfering relationship may, for example as shown at FIG. 18, be a nib 442 on the valve stem gate being disposed between a pair of bosses 444 disposed on the valve body at the medial valve body portion 310′ thereof, the bosses being aligned in the reciprocation direction of the valve stem gate so that the nib can slid guidingly therebetween and therealong. However, other sliding interference fit configurations can be used, such as a slot formed in the valve body receiving the nib on the valve stem gate, or the nib being disposed on the valve body and being received by a slot formed in the valve stem gate.

Operation of the leadscrew drive system 400′ to reciprocate the valve stem 320′ and the valve stem gate is as described with respect to FIGS. 13 and 14, except now the anti-rotation feature 428′ is via the sliding interference fit 440′.

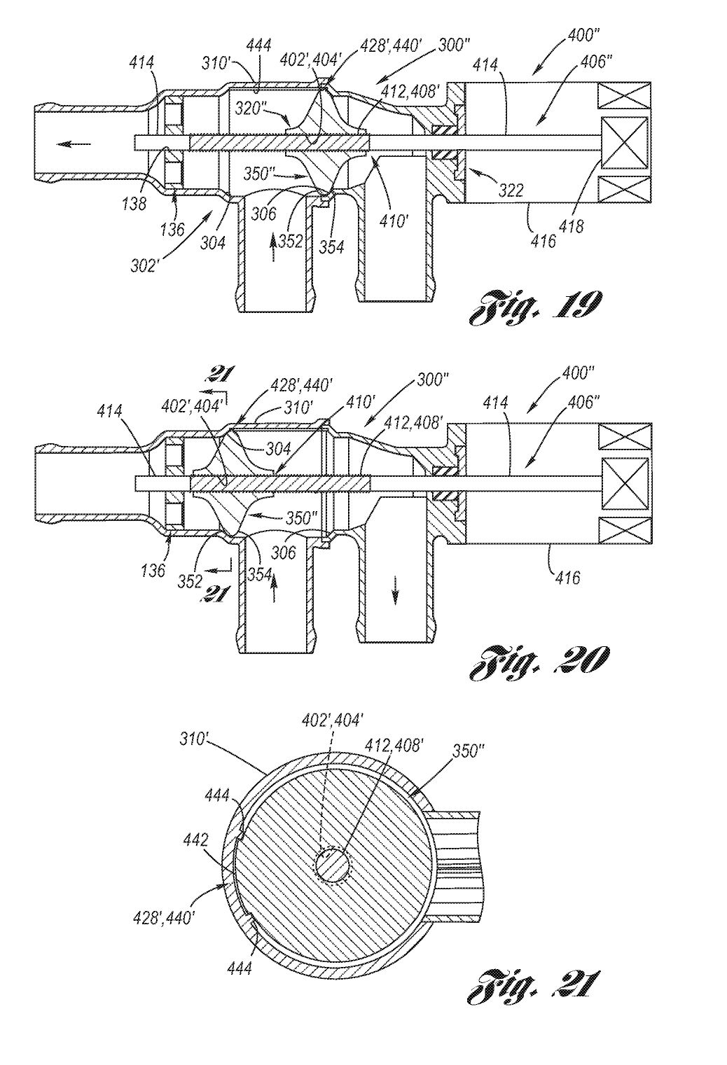

In yet further accordance with the present invention, FIGS. 19 through 21 show a third example of the leadscrew drive system 400″ for reciprocating the valve stem gate 350″ between the first and second valve seats 304, 306.

The valve stem of the three-way dual seat valve 300″ is truncated, wherein this truncated valve stem 320″ and the valve stem gate 350″ are provided with a threaded through bore 402′ that serves as the nut 404′ of a leadscrew 410′ of the leadscrew drive system 400″. A partly threaded shaft 406″ provides two roles: 1) the threaded portion 412 thereof serves as the screw 408′ of the leadscrew 410′, wherein the screw is threadingly engaged on the nut 404′; and 2) the non-threaded guided portions thereof 414 serve as a valve stem counterpart for reciprocal guidance at the gland 322 and at the stem guide opening (as per FIG. 3), wherein the guided portions serve, defacto, as the truncated portion of the valve stem. The partly threaded shaft 406″ is drivingly connected to an electric motor 416, as for example a stepper motor, wherein by way of example the partly threaded shaft may be connected by gearing or directly (as shown) to the armature 418. By way of example, the stator 420 is connected to an external electrical circuit including an electronic control module having programming which reacts in a predetermined manner to data sensed by one or more sensors (as per FIG. 13). The electric motor 416 is compactly connected with the valve body 302′, for example disposed in circumscribing relation to the gland 322.

As in FIG. 16, an anti-rotation feature 428′ is provided in which the valve stem 320″ is prevented from rotating with respect to the valve body 302′. In this regard, the valve stem gate 350″ now has a sliding interference fit 440′ with respect to the valve body which prevents relative rotation, but allows relative reciprocation. This interfering relationship may, for example as shown at FIG. 21, be a nib 442 on the valve stem gate being disposed between a pair of bosses 444 disposed on the valve body at the medial valve body portion 310″ thereof, the bosses being aligned in the reciprocation direction of the valve stem gate so that the nib can slid guidingly therebetween and therealong. However, other sliding interference fit configurations can be used, such as a slot formed in the valve body receiving the nib on the valve stem gate, or the nib being disposed on the valve body and being received by a slot formed in the valve stem gate.

In operation, the truncated valve stem 320″ is reciprocated by the leadscrew drive system 400″, wherein when electric motor 416 (that is to say more particularly the armature 418 thereof) rotates, the partly threaded shaft 406″ rotates with respect to the threaded through bore 402′ in that the valve stem gate 350″ is prevented from rotating by the anti-rotation feature 428′ as described with respect to FIGS. 18 and 21. In response, for example, to electronic programming and sensed data available to an electronic control module (as per FIG. 13), the electric motor is selectively actuated to rotate the screw 408′ of the leadscrew 410′ clockwise or counterclockwise, whereupon the nut 404′ of the leadscrew threads along the screw. Since 1) the nut is connected with the valve stem gate (and consequently the truncated valve stem 320″), 2) the valve stem gate is prevented from rotating with the screw because of the anti-rotation feature 428′, and 3) the partly threaded shaft (e.g., the screw) is non-reciprocally mounted to the electric motor such that it is non-reciprocal with respect to the valve body, rotation of the screw results in reciprocation of the truncated valve stem and the valve stem gate thereof between the position shown in FIG. 20, wherein the valve stem gate is sealingly seated at the first valve seat 304 to the position shown at FIG. 19, wherein the valve stem gate is sealingly seated at the second valve seat 306, and anywhere inbetween (as per the view at FIG. 1), wherein fluid flow is controlled as described hereinabove.

To those skilled in the art to which this invention appertains, the above described preferred embodiment may be subject to change or modification. Such change or modification can be carried out without departing from the scope of the invention, which is intended to be limited only by the scope of the appended claims.

1. A three-way dual seat valve, comprising:
a valve body comprising a medial valve body portion, a first distal valve body portion at a first end of the medial valve body portion, and a second distal valve body portion at a second end of the medial valve body portion;
a first valve seat disposed within said valve body comprising a first generally beveled surface adjoining said medial valve body portion at said first end thereof and juxtaposed said first distal valve body portion;
a second valve seat disposed within said valve body comprising a second generally beveled surface adjoining said medial valve body portion at said second end thereof and juxtaposed said second distal valve body portion; and
a valve stem gate reciprocally mounted with respect to said valve body, said valve stem gate being disposed in said medial valve body portion of said valve body, said valve stem gate comprising:
a first gate face configured for sealing engagement with said first valve seat when said valve stem gate is moved so that said valve stem gate abuts said first valve seat; and
a second gate face configured for sealing engagement with said second valve seat when said valve stem gate is moved so that said valve stem gate abuts said second valve seat.

2. The three-way dual seat valve of claim 1, further comprising reciprocation means for selectively reciprocating said valve stem gate between the sealing engagement with said first and second valve seats and to any position in said medial valve body portion disposed therebetween.

3. The three-way dual seat valve of claim 2, wherein said reciprocation means comprises a leadscrew drive system reciprocatingly connected with said valve stem gate.

4. The three-way dual seat valve of claim 3, wherein said leadscrew drive system comprises:
an electrical drive system;
a leadscrew comprising:
a screw drivingly connected to said electrical drive system; and
a nut connected with said valve stem gate, said screw being threadingly engaged on said nut; and
an anti-rotation feature interposed said valve body and said valve stem gate which permits said valve stem gate to reciprocate, but not to rotate, with respect to said valve body;
wherein rotation of said screw by said electrical drive system results in said screw to rotatingly thread in said nut and thereby cause said valve stem gate to reciprocate with respect to said first and second valve seats.

5. The three-way dual seat valve of claim 4, further comprising a valve stem connected with said valve stem gate, said valve stem having a blind bore; wherein said leadscrew drive system further comprises said nut being disposed in said blind bore.

6. The three-way dual seat valve of claim 5, wherein said anti-rotation feature comprises a sliding interference fit interposing said valve body at said medial valve body portion and said valve stem gate.

7. The three-way dual seat valve of claim 5, further comprising:
a valve stem connected with said valve stem gate, said valve stem having a non-circular portion; and
a valve stem guide connected with said first distal valve body portion and guidingly interfaced with said non-circular portion of said valve stem via a complimentarily shaped non-circular stem guide opening, said valve stem guide having a fluid flow passage therethrough;
wherein said anti-rotation feature comprises a sliding interference fit of said non-circular portion of said valve stem with said non-circular stem guide opening.

8. The three-way dual seat valve of claim 4, further comprising said valve stem guide having a through bore; wherein said leadscrew drive system further comprises said nut being disposed in said through bore.

9. The three-way dual seat valve of claim 8, wherein said anti-rotation feature comprises a sliding interference fit interposing said valve body at said medial valve body portion and said valve stem gate.

10. A three-way dual seat valve, comprising:
a valve body comprising a medial valve body portion, a first distal valve body portion at a first end of the medial valve body portion, and a second distal valve body portion at a second end of the medial valve body portion;
a first valve seat disposed within said valve body comprising a first generally beveled surface adjoining said medial valve body portion at said first end thereof and juxtaposed said first distal valve body portion;
a second valve seat disposed within said valve body comprising a second generally beveled surface adjoining said medial valve body portion at said second end thereof and juxtaposed said second distal valve body portion;
a valve stem gate reciprocally mounted with respect to said valve body, said valve stem gate being disposed in said medial valve body portion of said valve body, said valve stem gate comprising:
a first gate face configured for sealing engagement with said first valve seat when said valve stem gate is moved so that said valve stem gate abuts said first valve seat; and
a second gate face configured for sealing engagement with said second valve seat when said valve stem gate is moved so that said valve stem gate abuts said second valve seat; and
a leadscrew drive system comprising:
an electrical drive system;
a leadscrew, comprising:
a screw drivingly connected to said electrical drive system; and
a nut connected with said valve stem gate, said screw being threadingly engaged on said nut; and
an anti-rotation feature interposed said valve body and said valve stem gate which permits said valve stem gate to reciprocate, but not to rotate, with respect to said valve body;
wherein rotation of said screw by said electrical drive system results in said screw to rotatingly thread in said nut and thereby cause said valve stem gate to reciprocate with respect to said first and second valve seats.

11. The three-way dual seat valve of claim 10, further comprising a valve stem connected with said valve stem gate, said valve stem having a blind bore; wherein said leadscrew drive system further comprises said nut being disposed in said blind bore.

12. The three-way dual seat valve of claim 11, wherein said anti-rotation feature comprises a sliding interference fit interposing said valve body at said medial valve body portion and said valve stem gate.

13. The three-way dual seat valve of claim 11, further comprising:
a valve stem connected with said valve stem gate, said valve stem having a non-circular portion; and
a valve stem guide connected with said first distal valve body portion and guidingly interfaced with said non-circular portion of said valve stem via a complimentarily shaped non-circular stem guide opening, said valve stem guide having a fluid flow passage therethrough;
wherein said anti-rotation feature comprises a sliding interference fit of said non-circular portion of said valve stem with said non-circular stem guide opening.

14. The three-way dual seat valve of claim 10, further comprising said valve stem guide having a through bore; wherein said leadscrew drive system further comprises said nut being disposed in said through bore.

15. The three-way dual seat valve of claim 14, wherein said anti-rotation feature comprises a sliding interference fit interposing said valve body at said medial valve body portion and said valve stem gate.
